(19) United States
(12) Patent Application Publication
(10) Pub. No.: US 2020/0092800 A1
(43) Pub. Date: Mar. 19, 2020

(54) Invalid System Information Handling in User Equipment

(71) Applicant: Google LLC, Mountain View, CA (US)

(72) Inventor: Teming Chen, Taipei City (TW)

(73) Assignee: Google LLC, Mountain View, CA (US)

(21) Appl. No.: 16/574,559

(22) Filed: Sep. 18, 2019

Related U.S. Application Data
(60) Provisional application No. 62/732,710, filed on Sep. 18, 2018.

(51) Int. Cl. H04W 48/16; H04W 8/30; H04W 72/02; H04W 48/02; H04W 48/10; H04W 28/02

(52) U.S. Cl. CPC H04W 48/16; H04W 8/30; H04W 72/02; H04W 28/0268; H04W 48/10; H04W 28/0215; H04W 28/0247; H04W 48/02

(57) ABSTRACT

The present disclosure describes methods, devices, systems, and procedures for the handling of invalid system information in user equipment. In aspects, a user equipment (110) communicating with a base station (120) acquires first system information (502, 602, 702, 802, 902), stores the first system information (504, 604, 704, 804, 904), and determines if one or more blocks of stored first system information are invalid (506, 606, 706, 806, 906). If the user equipment determines that one or more blocks of stored first system information are invalid, then the user equipment determines at least one service requirement (508, 608, 708, 808, 908) of the user equipment. The user equipment manages the system information based on the service requirement of the user equipment.

### RELATED APPLICATION

This application claims priority to U.S. Provisional Patent Application Ser. No. 62/732,710 filed Sep. 18, 2018, the disclosure of which is incorporated by reference herein in its entirety.

### BACKGROUND

A user equipment (UE) communicates with a network through a base station. In general, the UE requires system information from the base station to establish communication with the base station. The system information can include, for example, channel information, bandwidth configurations, and so forth, thereby enabling the UE to configure itself accordingly. The UE stores the system information for future use and reference upon receiving the system information.

While the UE stores the system information, many aspects of the system information can change over time. As a result, the UE determines if the stored system information is still valid and if the stored system information is no longer valid (e.g., the stored system information is old, the system information has changed), the UE obtains updated system information. In some situations, this practice results in the UE obtaining updated system information related to a service that the UE no longer needs.

### SUMMARY

This disclosure describes techniques and apparatuses for the handling of invalid system information in user equipment (UE). In aspects, the user equipment determines that a system information block is invalid and obtains updated system information if there is a related service requirement. These techniques and apparatuses decrease the number of system information blocks of system information obtained needlessly by UE, thereby increasing the battery life of the UE, as well as freeing up network resources. These techniques and apparatuses save storage space on the UE, in that the UE does not need to store copies of system information for base stations that the UE does not require. These techniques and apparatuses decrease the number of system information blocks of system information needlessly obtained, thereby decreasing power expended by the UE in processing and handling such information, thereby increasing the battery life of the UE.

Aspects described below include a method performed by a UE communicating with a base station. The UE receives a first system information message including first system information from the base station. The UE stores the first system information. The UE determines that one or more blocks of the stored first system information are invalid and determines at least one service requirement of the user equipment. The UE manages the stored first system information based on the at least one service requirement of the user equipment.

Aspects described below also include a UE operating within a cell of a base station. The UE includes a processor, one or more transceivers, and a computer-readable storage media (CRM). The CRM having stored thereon instructions that, responsive to execution by the processor, cause the processor to perform operations. The processor receiving a first system information message (including first system information) from the base station; storing the first system information; determining if one or more blocks of the stored first system information are invalid system information; responsive to determining if one or more blocks of the stored first system information are invalid, determining at least one service requirement of the user equipment; and managing the first system information based on the at least one service requirement of the user equipment.

Aspects described below also include an apparatus having at least one antenna, at least one processor, a wireless transceiver, and a computer-readable storage media. The antenna is configured to receive a system information message from a base station. The computer-readable storage media includes computer-executable instructions that, responsive to execution by the processor, implement a system information control module. The system information control module is configured to generate a pilot signal that includes a system information request. The system information control module is also configured to analyze the received system information message to determine system information and to process it. The system information control message is also configured to determine the system requirements of the apparatus. The system information control module is also configured to manage the system information based on the service requirements of the apparatus. The system information control module is also configured to store the system information. The system information control module is also configured to determine the validity of stored system information. The system information control module is also configured to obtain new system information from the base station.

Aspects described below also include one or more computer-readable storage media storing executable instructions, that, responsive to execution by a processor, implement a system information control module. The system information control module is configured to generate a pilot signal that includes a system information request. The system information control module is also configured to analyze the received system information message to determine system information and to process it. The system information control message is also configured to determine the system requirements of the apparatus. The system information control module is also configured to manage the system information based on the service requirements of the apparatus. The system information control module is also configured to store the system information. The system information control module is also configured to determine the validity of stored system information. The system information control module is also configured to obtain new system information from the base station.

Aspects described below also include a method comprising applying, by a device, a system information acquisition procedure to acquire system information from a system information message sent by the base station. The method includes the device storing the acquired system information. The method includes the device determining if one or more blocks of the stored system information are invalid system information. Based on the UE determining that one or more blocks of the stored system information are invalid, the method includes the device performing a service requirements procedure to determine the service requirements of the apparatus. Based on the determined service requirements of the apparatus, the method may include the apparatus acquiring new system information from the base station or may include the apparatus not acquiring new system information from the base station. Where the method includes the apparatus acquiring new system information, the method also includes storing the acquired system information.

Aspects described below also include a system comprising means for determining the validity of stored system information, means for determining service requirements for a device to determine if a replacement system information message needs to be received, and if so, means for analyzing a received system information message from a base station to determine system information to replace invalid stored system information.

### BRIEF DESCRIPTION OF THE DRAWINGS

This document describes apparatuses for and techniques of handling of invalid system information in user equipment with reference to the following drawings. The same numbers are used throughout the drawings to reference like features and components:

FIG. 1 illustrates an example wireless network environment in which various aspects of the handling of invalid system information in user equipment can be implemented.

FIG. 2 illustrates an example environment in which various aspects of the handling of invalid system information in user equipment can be implemented.

FIG. 3 illustrates an example device diagram for devices that can implement various aspects of the handling of invalid system information in user equipment.

FIG. 4 illustrates details of data and control transactions between user equipment and a base station for the handling of invalid system information in user equipment.

FIG. 5 illustrates an example method of handling invalid system information in user equipment.

FIG. 6 illustrates an example method of handling invalid system information in user equipment.

FIG. 7 illustrates an example method of handling invalid system information in user equipment.

FIG. 8 illustrates an example method of handling invalid system information in user equipment.

FIG. 9 illustrates an example method of handling invalid system information in user equipment.

### DETAILED DESCRIPTION

Overview

This document describes techniques and apparatuses for the handling of invalid system information in UE. These techniques and devices are designed to improve communication performance by tailoring the handling of invalid system information in user equipment or a group of user equipment. These customizations decrease power usage for the UE, conserve storage space on the UE, and conserve network resources.

Instead of requesting new system information from the base station when stored system information is determined to be invalid (e.g., upon expiration of a three (3) hour timer, upon comparing value tags and determining a difference), these techniques allow the UE to determine if it will need at least one service for which one or more blocks of the system information contains information before requesting, reacquiring, and/or storing system information determined to be invalid. If the UE does not require (cannot utilize) the system information, then the UE and conserves transmission power by not requesting or acquiring system information from a base station.

This document describes techniques and devices for the handling of invalid system information in a UE. In some situations, a UE may be provided with system information (e.g., channel information, bandwidth configurations, numerology), to enable the UE to configure itself, establish communication with the base station, and obtain certain services from the base station. As time passes and as the UE's service needs change, the stored system information may be deemed to be invalid and may not include the most current information needed for the UE to configure itself, establish communication with the base station, and obtain certain services from the base station. A change in the UE's service needs can result in the UE not further needing certain services provided by the base station. Requiring the UE to acquire and replace all invalid system information may cause the UE to needlessly acquire and store one or more block of system information it does not need.

In aspects, the described techniques and devices improve communication performance by triggering the UE to determine which blocks of invalid system information are needed before reacquiring and storing such acquired system information. By only obtaining system information that is needed, power usage for the UE decreases, storage space on the UE is conserved, and network resources are conserved.

While features and concepts of the described systems and methods for the handling of invalid system information in user equipment can be implemented in any number of different environments, systems, devices, and/or various configurations, aspects for the handling of invalid system information in user equipment are described in the context of the following example devices, systems, and configurations.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Example Environments

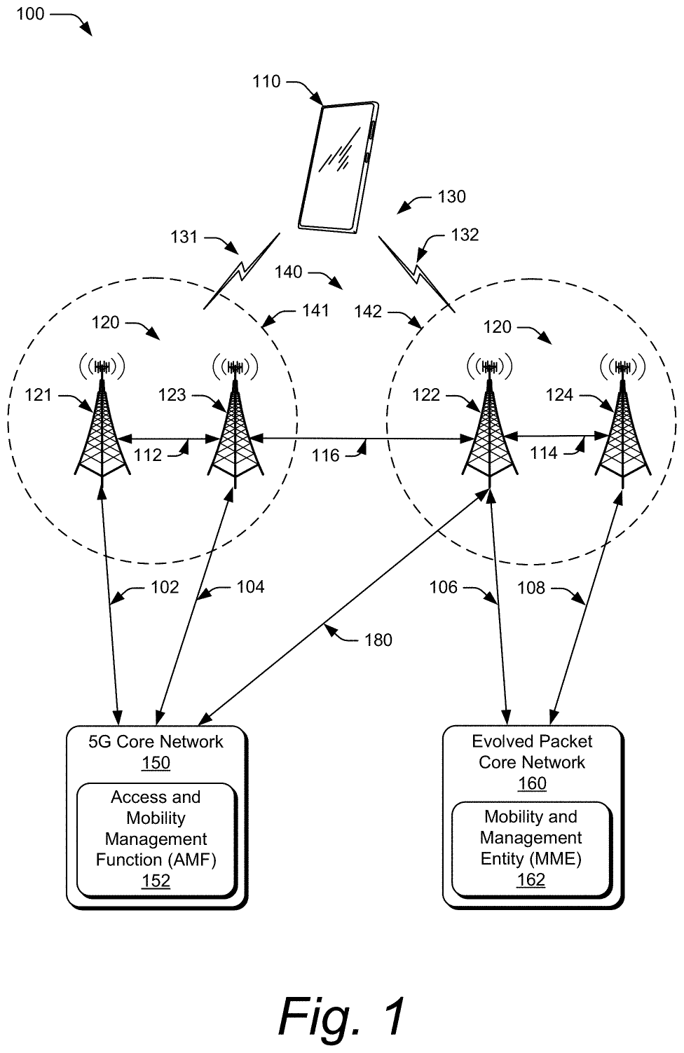

FIG. 1 is an illustration of an example wireless network in which various aspects of the handling of invalid system information in user equipment may be embodied. In the example environment 100, a UE 110 communicates with one or more base stations 120 (illustrated as base stations 121, 122, 123, and 124) through one or more wireless communication links 130 (wireless link 130), illustrated as wireless links 131 and 132. For simplicity, the UE 110 is implemented as a smartphone but may be implemented as any suitable computing or electronic device, such as a mobile communication device, modem, cellular phone, gaming device, navigation device, media device, laptop computer, desktop computer, tablet computer, smart appliance, vehicle-based communication system, or an Internet-of-Things (IoT) device such as a sensor or an actuator. The base stations 120 (e.g., an Evolved Universal Terrestrial Radio Access Network Node B, E-UTRAN Node B, evolved Node B, eNodeB, eNB, Next Generation Node B, gNode B, gNB, ng-eNB, or the like) may be implemented in a macrocell, microcell, small cell, picocell, or the like, or any combination thereof.

The base stations 120 communicate with the UE 110 using the wireless links 131 and 132, which may be implemented as any suitable type of wireless link. The wireless links 131 and 132 include control and data communication, such as downlink of data and control information communicated from the base stations 120 to the UE 110, uplink of other data and control information communicated from the UE 110 to the base stations 120, or both. The wireless links 130 may include one or more wireless links (e.g., radio links) or bearers implemented using any suitable communication protocol or standard, or combination of communication protocols or standards such as 3rd Generation Partnership Project Long-Term Evolution (3GPP LTE), Fifth Generation New Radio (5G NR), and so forth. Multiple wireless links 130 may be aggregated in a carrier aggregation to provide a higher data rate for the UE 110. Multiple wireless links 130 from multiple base stations 120 may be configured for Coordinated Multipoint (CoMP) communication with the UE 110.

The base stations 120 are collectively a Radio Access Network 140 (e.g., RAN, Evolved Universal Terrestrial Radio Access Network, E-UTRAN, 5G NR RAN or NR RAN). The RANs 140 are illustrated as an NR RAN 141 and an E-UTRAN 142. The base stations 121 and 123 in the NR RAN 141 connect to a Fifth Generation Core 150 (5GC 150) network. The base stations 122 and 124 in the E-UTRAN 142 connect to an Evolved Packet Core 160 (EPC 160). Optionally or additionally, a base station 122 in the E-UTRAN 142 may connect to the 5GC 150 and EPC 160 networks.

The base stations 121 and 123 connect, at 102 and 104 respectively, to the 5GC 150 through an NG2 interface for control-plane signaling and using an NG3 interface for user-plane data communications. The base stations 122 and 124 connect, at 106 and 108 respectively, to the EPC 160 using an Si interface for control-plane signaling and user-plane data communications. Optionally or additionally, if the base station 122 connects to the 5GC 150 and EPC 160 networks, the base station 122 connects to the 5GC 150 using an NG2 interface for control-plane signaling and through an NG3 interface for user-plane data communications, at 180.

In addition to connections to core networks, the base stations 120 may communicate with each other. For example, the base stations 121 and 123 communicate through an Xn interface at 103, the base stations 122 and 123 communicate through an Xn interface at 105, and the base stations 122 and 124 communicate through an X2 interface at 114. The base station 122, connected to both the 5GC 150 and the EPC 160, may communicate with the base stations 121 and/or 123 using the Xn interface, as illustrated at 116.

The 5GC 150 includes an Access and Mobility Management Function 152 (AMF 152), which provides control-plane functions such as registration and authentication of multiple UE 110, authorization, and mobility management in the 5G NR network. The EPC 160 includes a Mobility and Management Entity 162 (MME 162), which provides control-plane functions such as registration and authentication of multiple UE 110, authorization, or mobility management in the E-UTRA network. The AMF 152 and the MME 162 communicate with the base stations 120 in the RANs 140 and also communicate with multiple UE 110, using the base stations 120.

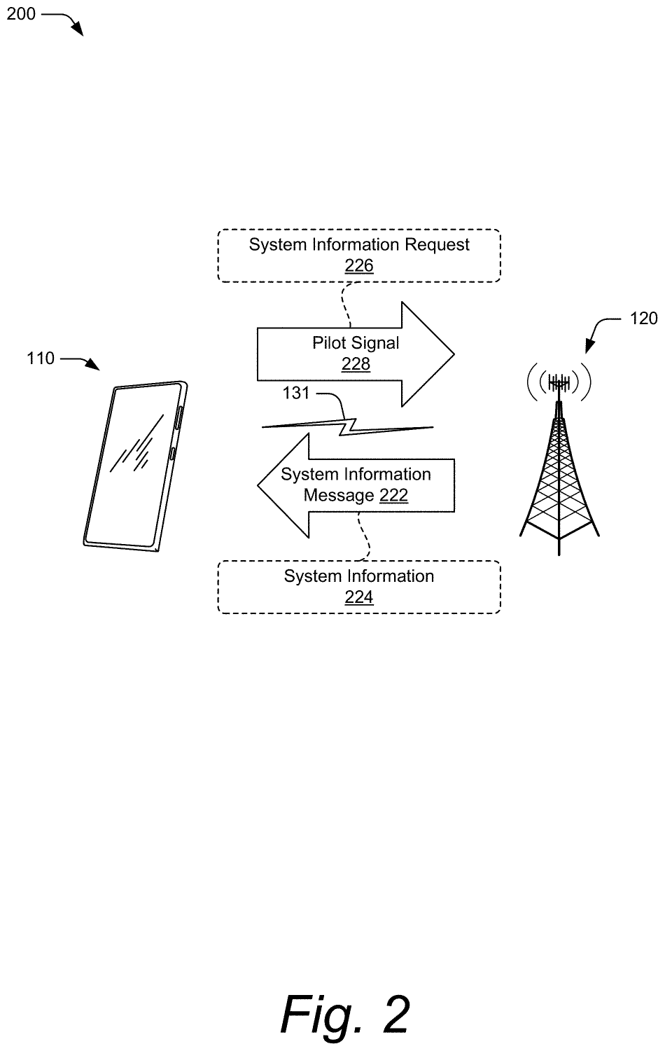

FIG. 2 is an illustration of an example environment in which various aspects of the handling of invalid system information in UE may be embodied. As explained in further detail herein and as illustrated in FIG. 1, the wireless communication link 131 may be used by an SI control module of the UE 110 to transmit a pilot signal 228 to the base station 120 and the wireless communication link 131 may be used by the base station 120 to transmit a system information message 222, including system information 224, to the UE 110. In some aspects, the system information message 222 may be transmitted by the base station 120 without first receiving the pilot signal 228. For instance, a system information message 222 including system information may be periodically broadcast by the base station 120.

In some aspects, the pilot signal 228 represents a system information request 226 requesting a system information message 222 from the base station 120 containing system information (e.g., system information that is not being broadcast by the base station 120). In other aspects, the system information request 226 requests system information 224 from the base station 120 for which the UE 110 determines it has an invalid stored copy thereof.

In response to the system information request message 226, the base station 120 can transmit one or more system information messages 222 (e.g., a third system information message) containing the requested system information 224 to the UE 110. The base station 120 can transmit system information messages 222 (e.g., a third system information message) to the UE 110 by a dedicated message, for instance, system information not broadcast in the active bandwidth part of the UE 110.

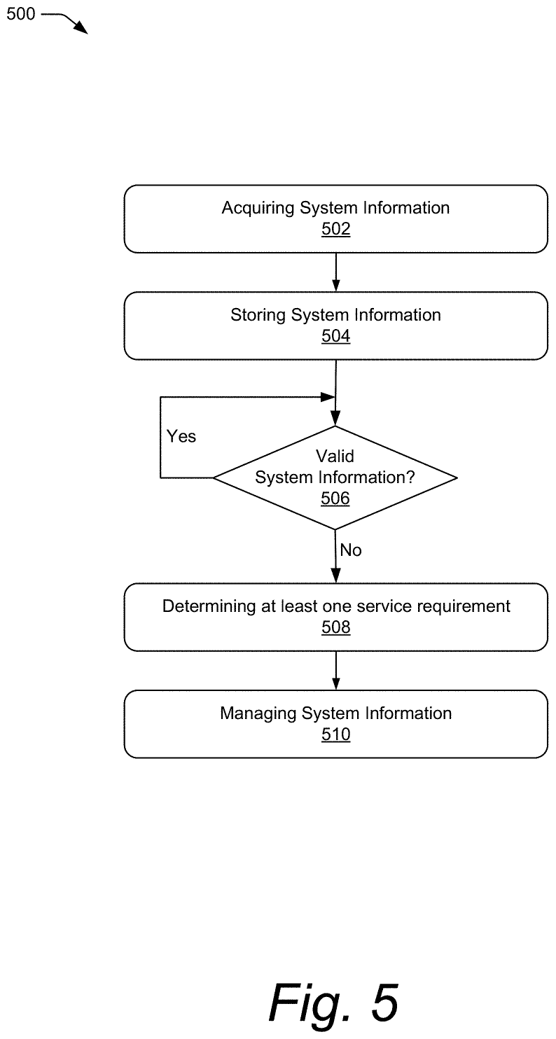

Alternatively, the base station 120 can transmit one or more system information messages 222 containing the requested system information to the UE 110 by broadcasting to all user equipment devices in the broadcast channel (BCH). In such an aspect, it is not necessary for the UE 110 to send a system information request 226 requesting the system information—the UE 110 can access the system information from the broadcast channel The SI control module 316 can at least partially implement the handling of invalid system information in UE (e.g., UE 110), as further illustrated in and described with respect to FIGS. 5, 6, 7, 8, and 9.

Example Devices

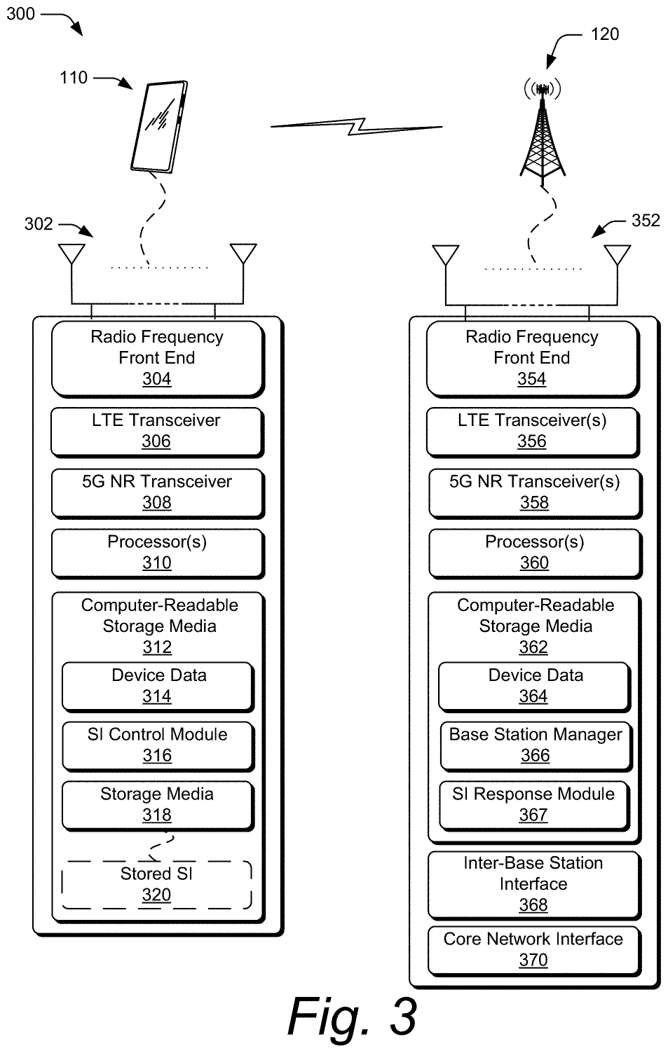

FIG. 3 illustrates example device diagrams 300 of the UE 110 and the base stations 120. The UE 110 and the base stations 120 may include additional functions and interfaces that omitted from FIG. 3 for the sake of clarity.

The UE 110 includes antennas 302, a radio frequency front end 304 (RF front end 304), an LTE transceiver 306 and/or a 5G NR transceiver 308 for communicating with base stations 120 in the 5G RAN 141 and/or the E-UTRAN 142. The RF front end 304 of the UE 110 can couple or connect the LTE transceiver 206 and/or the 5G NR transceiver 308 to the antennas 302 to facilitate various types of wireless communication. The antennas 302 of the UE 110 may include an array of multiple antennas that configured similar to or different from each other. The antennas 302 and the RF front end 304 can be tuned to, and/or be tunable to, one or more frequency bands defined by the 3GPP LTE and 5G NR communication standards and implemented by the LTE transceiver 206 and/or the 5G NR transceiver 308. Additionally, the antennas 302, the RF front end 304, the LTE transceiver 206, and/or the 5G NR transceiver 308 may be configured to support beamforming for the transmission and reception of communications with the base stations 120. By way of example and not limitation, the antennas 302 and the RF front end 304 can be implemented for operation in sub-gigahertz bands, sub-6 GHz bands, and/or above 6 GHz bands that are defined by the 3GPP LTE and 5G NR communication standards.

The UE 110 also includes at least one processor(s) 310 and computer-readable storage media 312 (CRM 312). In aspects, the CRM 312 has stored thereon instructions that responsive to execution by the processor 310, cause the processor 310 to execute methods described herein. The processor 310 may be a single-core processor or a multiple-core processor composed of a variety of materials (e.g., silicon, polysilicon, high-K dielectric, copper). The computer-readable storage media described herein excludes propagating signals. CRM 312 may include any suitable memory or storage device (e.g., storage media 318) such as random-access memory (RAM), static RAM (SRAM), dynamic RAM (DRAM), non-volatile RAM (NVRAM), read-only memory (ROM), or Flash memory useable to store device data 314 of the UE 110. The device data 314 includes user data, multimedia data, beamforming codebooks, applications, and/or an operating system of the UE 110, which are executable by the processor(s) 310 to enable user-plane communication, control-plane signaling, and user interaction with the UE 110.

CRM 312 also includes a system information control module 316 (SI control module 316). Alternatively or additionally, the SI control module 316 may be implemented in whole or part as hardware logic or circuitry integrated with or separate from other components of the UE 110. In at least some aspects, the SI control module 316 handles system information requests sent to the base station 120 and processes system information messages 222 and system information 224 received from the base station 120, to implement the techniques described herein.

In some aspects, the SI control module 316 generates the system information request 226 and receives a system information message 222 (and the system information 224 therein) from the base station 120. The SI control module 316 generates the pilot signal 228, which may include a system information request 226. The system information request 226 notifies the base station 120 that the UE 110 is requesting a system information message. The system information request 226 can also be transmitted autonomously to the base station 120 without a grant from the base station 120.

In some aspects, the base station 120 receives the pilot signal 228 from the UE 110. Responsive to receiving the pilot signal 228, the base station 120 provides the UE 110 configuration details by transmitting at least one system information message 222 containing system information 224 to the UE 110. In general, the system information 224 (e.g., channel information, bandwidth configurations, numerology) enables the UE 110 to configure itself and establish communication with the base station 120.

In some aspects, the SI control module 316 processes the system information 224. In some cases, the processing includes determining at least one service requirement of the UE 110. In some cases, the SI control module 316 processes stored system information 320 to determine if it is valid. The SI control module 316, responsive to determining that one or more blocks of the stored system information are invalid, may determine at least one service requirement of the UE 110. In some cases, the SI control module 316 processes system information stored on the UE 110 as well as information regarding the UE 110 as part of determining the system requirements of the UE 110. In some cases, the SI control module 316 manages the system information 224 based on the determined at least one service requirement of the UE 110. In some cases, the SI control module 316 requests and/or reacquires system information 224 from the base station 120 if the UE 110 if the determined system requirements indicate that the UE 110 needs the system information 224.

The device diagram for the base stations 120, shown in FIG. 3, includes a single network node (e.g., a gNode B). The functionality of the base stations 120 may be distributed across multiple network nodes or devices and may be distributed in any fashion suitable to perform the functions described herein. The base stations 120 include antennas 352, a radio frequency front end 354 (RF front end 354), one or more LTE transceivers 356, and/or one or more 5G NR transceivers 358 for communicating with the UE 110. The RF front end 354 of the base stations 120 can couple or connect the LTE transceivers 356 and the 5G NR transceivers 358 to the antennas 352 to facilitate various types of wireless communication. The antennas 352 of the base stations 120 may include an array of multiple antennas configured similar to or different from each other. The antennas 352 and the RF front end 354 can be tuned to, and/or be tunable to, one or more frequency band defined by the 3GPP LTE and 5G NR communication standards, and implemented by the LTE transceivers 356, and/or the 5G NR transceivers 358. Additionally, the antennas 352, the RF front end 354, the LTE transceivers 356, and/or the 5G NR transceivers 358 may be configured to support beamforming, such as Massive-MIMO, for the transmission and reception of communications with the UE 110.

The base stations 120 also include the processor(s) 360 and computer-readable storage media 362 (CRM 362). In aspects, the CRM 362 stores instructions that, responsive to execution by the processor 360, cause the processor 360 to execute methods described herein. The processor 360 may be a single-core processor or a multiple-core processor composed of a variety of materials (e.g., silicon, polysilicon, high-K dielectric, copper). CRM 362 may include any suitable memory or storage device such as random-access memory (RAM), static RAM (SRAM), dynamic RAM (DRAM), non-volatile RAM (NVRAM), read-only memory (ROM), or Flash memory useable to store device data 364 of the base stations 120. The device data 364 includes network scheduling data, radio resource management data, beamforming codebooks, applications, and/or an operating system of the base stations 120, which are executable by the processor(s) 360 to enable communication with the UE 110.

CRM 362 also includes a base station manager 366. Alternatively or additionally, the base station manager 366 may be implemented in whole or part as hardware logic or circuitry integrated with or separate from other components of the base stations 120. In at least some aspects, the base station manager 366 configures the LTE transceivers 356 and the 5G NR transceivers 358 for communication with the UE 110, as well as communication with a core network. The base stations 120 include an inter-base station interface 368, such as an Xn and/or X2 interface, which the base station manager 366 configures to exchange user-plane and control-plane data between another base station 120, to manage the communication of the base stations 120 with the UE 110. The base stations 120 include a core network interface 370 that the base station manager 366 configures to exchange user-plane and control-plane data with core network functions and entities.

CRM 362 also includes a system information response module 367 (SI Response Module 367). Alternatively or additionally, the system information response module 367 may be implemented in whole or part as hardware logic or circuitry integrated with or separate from other components of the base stations 120. In at least some aspects, the system information response module 367 is configured for processing the pilot signal 228 received from the UE 110.

In this example, an SI response module 367 is implemented in the CRM 362 of the base station 120. The SI response module 367 for receiving the pilot signal 228. The SI response module 367 analyzing the received pilot signal 228 to determine a system information request 226. The SI response module 367 may customize the transmission of the system information message 222 based on the system information request 226 received from the UE 110 through the pilot signal 228.

The SI control module 316 of the UE 110 applies a system information acquisition procedure to acquire the system information 224 from a system information message 222 sent by the base station 120. The SI control module 316 may apply the system information acquisition procedure upon cell selection (e.g., upon power on), cell-reselection, return from out of coverage, after reconfiguration with sync completion, after entering Next Generation Radio Access Network (NG-RAN) from another RAT, upon receiving an indication that system information has changed, upon receiving a Public Warning System (PWS) notification, and whenever the UE 110 does not have a valid version of stored system information at CRM 312 (e.g., stored as device data 314, stored on the storage media 318).

When the SI control module 316 acquires the system information message 222 from the base station 120, the UE 110 stores (e.g., locally) the acquired system information at CRM 312 (e.g., as device data 314, on the storage media 318) as stored system information 320. The stored system information 320 can include MasterInformationBlock (MIB), SystemInformationBlockType1 (SIB1), and/or one or more SIBs. The stored system information 320 is applied by the UE 110 until the UE 110 replaces the stored system information 320 at the CRM 312 with newly acquired system information from the base station 120, for instance, upon cell selection (e.g., upon power on), cell-reselection, return from out of coverage, after reconfiguration with sync completion, after entering a NG-RAN from another RAT, upon receiving an indication that the system information has changed, upon receiving a PWS notification, and whenever the UE does not have a valid version of the system information.

The SI control module 316 of the UE 110 determines at least one service requirement of the UE 110. In some cases, the SI control module 316 of the UE 110 performs a service requirements procedure to determine at least one service requirement of the UE 110. In some cases, if based on the determined service requirements new system information 224 is needed, then the SI control module 316 of the UE 110 obtains new system information 224.

The SI control module 316 of the UE 110 determines if one or more blocks of the stored system information 320 are invalid. In determining that one or more blocks of the stored system information 320 are invalid system information, the SI control module 316 of the UE 110 may validate the stored system information 320. The UE 110 may use an out of date (invalid) version of a stored SIB (e.g., after cell re-selection, upon return from out of coverage, upon return to coverage after the reception of a paging message from the base station 120). The UE 110 may be required to not use an out of date version of a MIB or a SIB1.

In some cases, the SI control module 316 of the UE 110 determines that one or more blocks of the stored system information are invalid if a validity duration timer expires and/or if the interval from when the system information was stored and/or most-recently validated otherwise exceeds a maximum time. The system information message 222 may also include information regarding a duration (e.g., a given time frame) for which stored system information 320 is valid and may be used by the UE 110. A timer implemented on the UE 110, such as implemented in computer-readable storage media 312, may be used to track the validity duration for stored system information 320.

The UE 110 may automatically deem stored system information invalid if it exceeds a maximum validity duration. Upon expiration of such a duration, the stored system information 320 may be released by the UE 110. In some cases, the UE 110 may release one or more blocks of the stored system information 320 before the duration of a timer associated with the stored system information 320 expires and/or if the timer is halted and/or stopped (e.g., such as responsive to processing a public land mobile network (PLMN) selection request, responsive to transitioning to an idle state). The SI control module 316 of the UE 110 may start the validity duration timer upon storing the system information 224 and/or may otherwise set a maximum validity duration for the stored system information 320. A version of stored system information 320 may also have a validity duration of a set time (e.g., three (3) hours) from the moment it was successfully confirmed as valid and/or reconfirmed as valid by the UE 110. The SI control module 316 of the UE 110 may delete any stored version of system information after such a set time from the moment the UE 110 successfully confirmed the system information as valid.

In some cases, the SI control module 316 of the UE 110 determines that one or more blocks of the stored system information are invalid by checking if one or more information elements in the stored system information 320 are different from the same information element(s) in the SIB1 received from the base station 120. In an example, the SI control module 316 of the UE 110 may compare if one or more of the information elements (e.g., value tags, systemInfoValueTag, CellIdentity, systemInfoAreaIdentifier) in the stored system information 320 are different than the same information element(s) in the SIB1 received from the base station 120.

The SI control module 316 of the UE 110 can, for each stored version of a SIB other than SIB1, consider the stored SIB as valid for the cell of the base station 120 if the stored SIB is an area-specific SIB and if the information elements systemInfoAreaIdentifier and systemInfoValueTag included in the SIB1 received from the base station 120 are identical to the information elements systemInfoAreaIdentifier and systemInfoValueTag associated with stored version of that SIB. The SI control module 316 of the UE 110 can, for each stored version of a SIB other than SIB1, consider the stored SIB as valid for the cell of the base station 120 if the stored SIB is cell-specific and if the information elements systemInfoValueTag and CellIdentity included in the SIB1 received from the base station 120 is identical to the information elements systemInfoValueTag and CellIdentity associated with stored version of that SIB.

If the UE 110 has a stored valid version of the SIB(s) associated with the information element systemInfoAreaIdentifier and the information element systemInfoValueTag (systemInfoConfigurationIndex) in the acquired SIB1, the UE 110 uses the stored version of the SIB(s).

If the SIB1 message indicates that one or more of the SIB(s) are only provided on request, the SI control module 316 of the UE 110 sends a system information request 226 through a pilot signal 228 to the base station 120 to acquire the system information message(s) (if needed). Upon receiving a system information message 222, the UE 110 can then perform the actions for the system information 224 in the acquired system information message 222.

In some cases, the SI control module 316 of the UE 110 determines that one or more blocks of the stored system information 320 are invalid upon the UE 110 receiving a paging message, such as a system information change indication (e.g., paging message), from the base station 120.

In some cases, the SI control module 316 of the UE 110 verifies the stored system information to determine if the stored system information is still a valid version of the system information. This verification can be done by receiving the current SIB1 message from the base station and comparing the tags (e.g., systemInfoValueTag) in the SIB1 to the stored system information to determine if they are identical. If the tags are identical, then the UE 110 can consider the stored system information as being valid for the cell of the base station 120, whereas if the compared tags are not identical, then the UE 110 can consider the stored system information as not being valid for the cell of the base station 120.

Upon determining that the stored system information 320 is invalid, if the UE 110 does not already have new system information, the SI control module 316 of the UE 110 can acquire updated (new) system information 224 from the base station 120. The UE 110 stores one or more blocks of the new (valid) system information, overwriting one or more blocks of the old stored system information (the invalid system information), and this currently stored system information can be applied by the UE 110 until the SI control module 316 determines that the stored system information is not a valid version.

As discussed with respect to FIG. 1, the wireless link 131 and 132 can include a downlink of data and control information communicated from the base stations 120 to the UE 110, an uplink of other data and control information communicated from the UE 110 to the base station(s) 120, or both. The base station 120 broadcasts system information messages 222 to UE 110 camped on the base station 120. The system information message(s) 222 include system information 224.

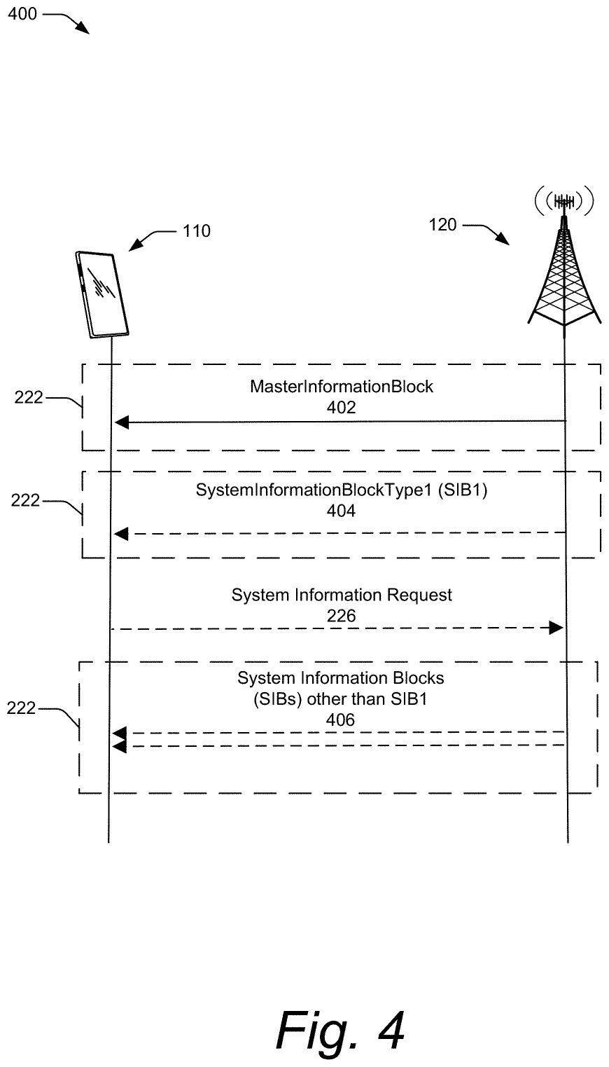

FIG. 4 illustrates example details of data and control transactions between devices 400 for the handling of invalid system information in UE. As illustrated in FIG. 4, the system information message(s) 222 include system information divided into a MasterInformationBlock (MIB) 402 and several system information blocks. The system information blocks include a SystemInformationBlockType1 (SIB1) 404 and several system information blocks (SIBs) 406 other than SIB 1. Reference to “system information” herein means one or more blocks of system information, unless the context clearly indicates otherwise.

The base station 120 can periodically transmit SIBs 406 other than SIB1 and/or the base station 120 can transmit SIBs 406 other than SIB1 to the UE 110 in response to a system information request 226 from the UE 110.

The MIB 402 is carried on a message transmitted on a broadcast channel (BCH) and includes parameters that are needed by the UE 110 to acquire the SIB1 404 from the base station 120. A message transmitted on the downlink shared channel (DL-SCH) carries SystemInformationBlockType1 404. SIB1 404 is cell-specific, and as such is applicable only within a cell that provides SIB1 404. SIB1 404 includes information regarding the availability and scheduling (e.g., periodicity, system information window size (SI-window size)) of the SIBs 406, with an indication whether one or more of such SIBs 406 are only provided on demand and, in that case, the configuration needed by the UE 110 to request, from the base station 120, one or more system information messages 222 containing such SIBs 406.

For the acquisition of the MIB 402 and the SIB1 404, the UE 110 applies the specified broadcast control channel and acquires the MIB 402 broadcast message from the base station 120. Upon receiving the MIB 402, the UE 110 stores the acquired MIB 402 at CRM 312 (e.g., as device data 314, on the storage media 318). The UE 110 then acquires the SIB1 404 from the base station 120. Upon receiving SIB1 404, the UE 110 stores the acquired SIB1 404 at CRM 312 (e.g., as device data 314, on the storage media 318) and performs the actions in SIB1 404 for the acquired system information message. The UE 110 can send a system information request message 226 to the base station 120 requesting one or more system information messages containing the SIBs 406.

SIBs 406 are carried in system information messages 222 transmitted on the downlink shared channel (DL-SCH). SIBs 406 that have the same periodicity may be mapped to the same system information message 222. SIBs 406 can be configured to be cell-specific and/or area-specific. A cell-specific SIB is applicable only within a cell that provides the SIB. An area-specific SIB is applicable within an area referred to as a System Information Area (systemInformationAreaID).

SIBs 406 include but are not limited to SIB2, SIB3, SIB4, SIB5, SIB6, SIB7, SIB8, SIB9, SIB10, SIB11, SIB12, SIB13, and newly added SIBs. For example:
SIB2 contains cell re-selection information common for intra-frequency, inter-frequency, and/or inter-RAT cell re-selection (i. e., applicable for more than one type of cell re-selection but not necessarily all) as well as intra-frequency cell re-selection information other than neighboring cell-related.
SIB3 contains neighboring cell-related information relevant only for intra-frequency cell re-selection.
SIB4 contains information relevant only for inter-frequency cell re-selection, i.e., information about other New Radio frequencies and inter-frequency neighboring cells relevant for cell re-selection.
SIB5 contains information relevant only for inter-RAT cell re-selection, i.e., information about Evolved Universal Terrestrial Radio Access (E-UTRA) frequencies and E-UTRAs neighboring cells relevant for cell re-selection.
SIB6 contains an Earthquake & Tsunami Warning System (ETWS) primary notification.
SIB7 contains an ETWS secondary notification.
SIB8 contains a Commercial Mobile Alert Service (CMAS) notification.
SIB9 contains information related to Global Positioning System (GPS) time and Coordinated Universal Time (UTC).
SIB10 and SIB11 contain information related to the Earthquake and Tsunami Warning System.
SIB12 contains CMAS information.
SIB13 contains information to acquire Multimedia Broadcast Multicast Service (MBMS) control information.

While SIB2 through SIB13 are described above, additional SIBs, including those defined in the future, are also possible.

Example Methods

FIGS. 5 through 9 depict example methods 500, 600, 700, 800, and 900 for handling invalid system information in user equipment (e.g., a UE). Methods 500, 600, 700, 800, and 900 are illustrated as sets of operations (or acts) performed but not necessarily limited to the order or combinations in which the operations are illustrated herein. Further, any of one or more of the operations may be repeated, combined, reorganized, or linked to provide a wide array of additional and/or alternate methods. In portions of the following discussion, reference is made to example wireless network environment 100 of FIG. 1, example environment 200 of FIG. 2, example device diagram 300 of FIG. 3, example details of data and control transactions between devices 400 of FIG. 4, and entities detailed in FIG. 1, the reference to which is made for example only. The techniques are not limited to performance by one entity or multiple entities operating on one device.

In method 500, the UE (e.g., UE 110 of FIG. 1) is in communication with a base station (e.g., base station 120 of FIG. 1). The UE may be implemented as any suitable computing or electronic device, such as a mobile communication device, a computing device, a client device, a mobile phone, a tablet computer, a laptop computer, a communication device, an entertainment device, a gaming device, a mobile gaming console, a personal media device, a media playback device, a charging station, an Advanced Driver Assistance System (ADAS), a point-of-sale (POS) transaction system, a health monitoring device, a drone, a camera, a wearable smart-device, a navigation device, a mobile-internet device (MID), an Internet home appliance capable of wireless Internet access and browsing, an IoT device, a Fifth Generation New Radio UE, and/or other types of user devices. The base station base may represent or be implemented as another device, radio access node, wireless communication node, or other suitable piece of equipment that facilitates wireless communication (using a wireless link) between UE and a communication network, such as a gNB base station, an eNB base station, an eNodeB base station, a base transceiver system, a Wireless Local Access Network (WLAN) router, a satellite, a terrestrial television broadcast tower, an access point, a peer-to-peer device, another smartphone acting as a base station, and so forth.

At 502, the UE acquires first system information from a system information message received from the base station. At 504, the UE stores the acquired first system information (e.g., as device data 314 at CRM 312 of FIG. 1, on the storage media 318 at CRM 312 of FIG. 1).

At 506, the UE determines if one or more blocks of the stored first system information are invalid system information. The UE may determine if one or more blocks of the stored first system information are invalid after a period of time (e.g., the duration of a timer). In some cases, the UE determines that one or more blocks of the stored first system information are invalid if a validity duration timer expires and/or if the interval from when the system information was stored and/or most-recently validated otherwise exceeds a maximum time. In some cases, the UE determines that one or more blocks of the stored first system information are invalid by checking if one or more information elements in the stored first system information are different from the same information element(s) in the SIB1 received from the currently camped/serving base station, for instance, the UE may check if one or more of the information elements systemInfoValueTag, CellIdentity, and systemInfoAreaIdentifier in the stored first system information are different than the same information element(s) in the SIB1 received from the base station. In some cases, the UE determines that one or more blocks of the stored first system information are invalid upon receipt of a paging message, such as a system information change indication informing the user equipment about a system information change, from the base station.

At 508, responsive to determining that one or more blocks of the stored first system information are invalid system information, the UE determines at least one service requirement of the UE. In an aspect, the UE determines at least one service requirement of the UE by performing a service requirements procedure. In some aspects, the service requirements of the UE relate to whether the UE is capable of handling a service (a user equipment service) related to (e.g., defined by, supported by, configured by, enabled by) the stored first system information determined to be invalid (e.g., the system information includes configuration information for the user equipment service). In one example, the invalid system information contains an MBMS configuration, the UE already closed the MBMS service, and as a result, the service requirements of the UE do not require re-acquisition of the MBMS configuration from updated system information. In another example, the invalid system information contains an MBSFN configuration, the UE already closed the MBSFN service, and as a result, the service requirements of the UE do not require re-acquisition of the MBSFN configuration from updated system information.

In other aspects, the service requirements of the UE can relate to whether a stored valid version of the system information is required for the UE to operate within a cell of the base station. For example, whether the invalid system information is required (required system information) for the UE. System information is required when the system information includes information related to a user equipment service the UE requires (can utilize) and/or information that the UE has already requested from the base station using the wireless link. System information may be required for the UE when the base station indicates to the UE that such system information is required (e.g., MIB and SIB1 may be required system information). System information may be required for the UE when the UE's capabilities support the system information (e.g., if a UE supports IoT capability, then the system information related to IoT is required system information for the UE). An example of the UE determining that the invalid system information is required system information for the UE at 508 is where the UE is an IoT device and the system information contains essential information for the functioning of the IoT device.

In other aspects, the service requirements of the UE can relate to whether the UE supports a user equipment service related to (e.g., defined by, supported by, configured by, enabled by) the system information determined to be invalid. For example, in some cases, this relates to whether the UE is capable of handling the system information determined to be invalid, such as whether a capability of the UE supports the user equipment service. Examples of equipment capability that can be determined include, but are not limited to, Minimization of Drive Test (MDT), Multimedia Broadcast Multicast Service (MBMS), Multimedia Broadcast Multicast Service Single Frequency Network (MBSFN), E-UTRA, and Global Navigation Satellite System (GNNS) (e.g., Global Positioning System (GPS)). In another example, equipment capability may relate to whether the UE is interested in receiving the services that the invalid system information contains information regarding. Other examples of possible UE interests include, but are not limited to, MBMS and/or MBSFN. In some cases, the service requirements of the UE relate to whether the UE wants to acquire and/or receive such invalid system information.

At 510, the UE manages the system information. In aspects, if based on the determined service requirements, new system information is needed (e.g., if one or more blocks of the stored first system information is invalid), the UE manages the system information by acquiring one or more blocks of new system information from the base station (e.g., from second system information in a second system information message). In some cases, the one or more blocks of the new system information are received by the UE from a periodic transmission broadcast in the cell by the base station. In some cases, the system information is not broadcast by the base station in the cell, and the UE acquires the new system information from the base station by sending a system information request to the base station and receiving a system information message including the system information (e.g., second system information in a second system information message) from the base station. The UE may overwrite the invalid system information with one or more blocks of the new (valid) system information. In some cases, the base station sends the system information to the UE through a dedicated message.

In method 600, the UE is in communication with a base station. At 602, the UE acquires first system information from a first system information message received from the base station, as described at 502 in FIG. 5. At 604, the UE stores the first system information (e.g., as device data 314 at CRM 312 of FIG. 1, on the storage media 318 CRM 312 of FIG. 1).

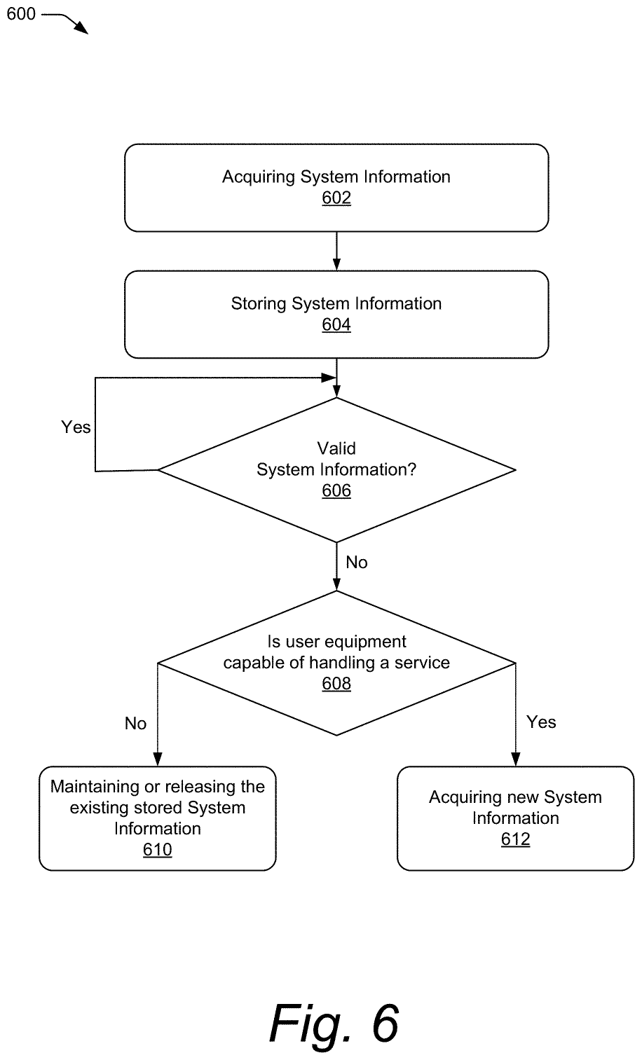

At 606, after a period of time, the UE determines that one or more blocks of the stored first system information are invalid, as described at 506 in FIG. 5. In some cases, at 606 in FIG. 6, the UE determines that one or more blocks of the stored first system information are invalid due to the expiration of a validity duration timer and/or if the interval from when the system information was stored and/or most-recently validated otherwise exceeds a maximum time, as described at 506 in FIG. 5. In some cases, at 606 in FIG. 6, the UE determines that one or more blocks of the stored first system information are invalid by checking for different information elements, as described at 506 in FIG. 5. In some cases, at 606 in FIG. 6, the UE determines that one or more blocks of the stored first system information are invalid due to receipt of a paging message from the network, as described at 506 in FIG. 5.

At 608, the UE performs a service requirement procedure to determine at least one service requirement of the UE relating to the invalid one or more blocks of stored first system information. At 608, the service requirements of the UE relate to whether the UE is capable of handling a service related to (e.g., defined by, supported by, configured by, enabled by) the stored first system information determined to be invalid (e.g., the system information includes configuration information for the service). In some cases, this is done by determining if a capability of the UE supports the service. For example, if the invalid system information includes an MDT configuration and the user equipment supports MDT services. Other examples of user equipment capabilities that can be determined at 608 include but are not limited to MBMS and/or MBSFN. In one example, the invalid system information contains an MBMS configuration, the UE already closed the MBMS service, and as a result, the service requirements of the UE do not require re-acquisition of the MBMS configuration from updated system information. In another example, the invalid system information contains an MBSFN configuration, the UE already closed the MBSFN service, and as a result, the service requirements of the UE do not require re-acquisition of the MBSFN configuration from updated system information.

At 610, in response to a determination by the UE that the UE is not capable of handling the service related to the invalid system information, the UE maintains (e.g., keeps) or releases (e.g., discards) the existing stored system information and does not reacquire such system information even though one or more blocks of the stored first system information are invalid.

At 612, in response to a determination by the UE that the UE is capable of handling the service related to the invalid system information, the UE acquires one or more blocks of new first system information from the base station (e.g., second system information in a second system information message), as described at 510 in FIG. 5. In some cases, at 612 in FIG. 6, the needed system information is not broadcast in the cell of the base station, and the UE acquires the new system information from the base station (e.g., in a second system information message), as described at 510 in FIG. 5. In some cases, at 612 in FIG. 6, the needed system information is broadcast in the cell of the base station, and the UE acquires the new system information from the broadcast system information, as described at 510 in FIG. 5. The UE may overwrite the invalid system information with one or more blocks of the new (valid) system information. In some cases, at 612 in FIG. 6, the needed system information is sent by the base station to the UE through a dedicated message, as described at 510 in FIG. 5.

In method 700, the UE is in communication with a base station. At 702, the UE acquires first system information from the base station, as described at 502 in FIG. 5. At 704, the UE stores the first system information (e.g., as device data 314 at CRM 312 of FIG. 1, on the storage media 318 CRM 312 of FIG. 1).

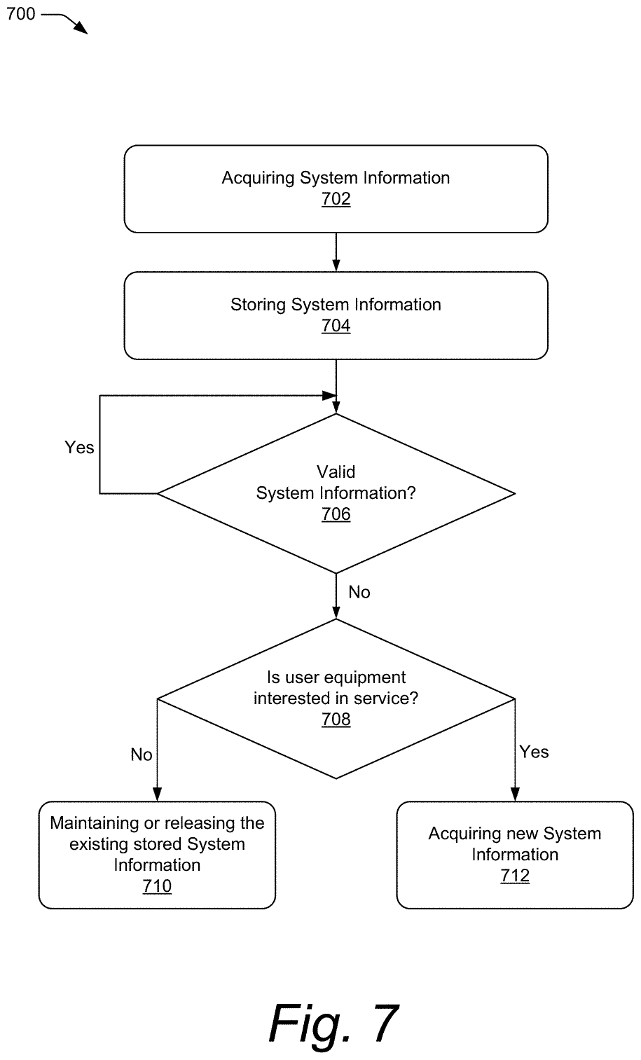

At 706, after a period of time, the UE determines that one or more blocks of the stored first system information are invalid, as described at 506 in FIG. 5. In some cases, at 706 in FIG. 7, the UE determines that one or more blocks of the stored first system information are invalid due to the expiration of a validity duration timer and/or if the interval from when the stored first system information was stored and/or most-recently validated otherwise exceeds a maximum time, as described at 506 in FIG. 5. In some cases, at 706 in FIG. 7, the UE determines that one or more blocks of the stored system information are invalid by checking for different information elements, as described at 506 in FIG. 5. In some cases, at 706 in FIG. 7, the UE determines that one or more blocks of the stored first system information are invalid due to receipt of a paging message from the network, as described at 506 in FIG. 5.

At 708, the UE performs a service requirement procedure to determine at least one service requirement of the UE relating to the invalid stored system information. At 708, the service requirements of the UE relate to whether the UE is interested in receiving the services that the invalid system information contains information regarding. For example, if the invalid system information relates to MDT and the UE supports and/or requires (can utilize) MDT services, then the UE is interested in receiving the services. Other examples of UE interests to receive that can be determined at 708 include, but are not limited to, MBMS, MBSFN, E-UTRA, and GPS.

At 710, in response to the UE determining that is not interested to receive the services that the invalid system information contains information regarding, the UE maintains (e.g., keeps) or releases (e.g., discards) the existing stored first system information and does not reacquire such system information even though the stored system information is invalid.

At 712, in response to the UE determining that it is interested to receive the services that the invalid system information contains information regarding, the UE acquires new system information from the base station, as described at 510 in FIG. 5. In some cases, at 712 in FIG. 7, the needed system information is not broadcast in the cell of the base station, and the UE acquires the new system information from the base station, as described at 510 in FIG. 5. In some cases, at 712 in FIG. 7, the needed system information is broadcast in the cell of the base station, and the UE acquires the new system information from the broadcast system information, as described at 510 in FIG. 5. The UE may overwrite the invalid system information with one or more blocks of the new (valid) system information. In some cases, at 712 in FIG. 7, the needed system information is sent by the base station to the UE through a dedicated message, as described at 510 in FIG. 5.

In method 800, the UE is in communication with a base station. At 802, the UE acquires first system information from the base station, as described at 502 in FIG. 5. At 804, the UE stores the first system information (e.g., as device data 314 at CRM 312 of FIG. 1, on the storage media 318 CRM 312 of FIG. 1).

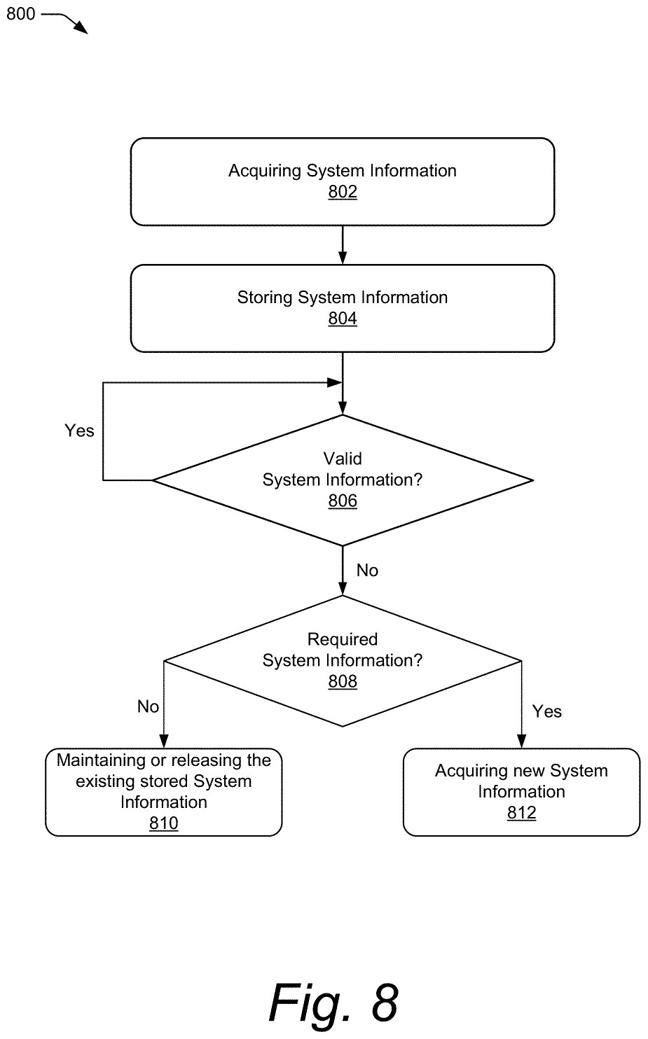

At 806, after a period of time, the UE determines that one or more blocks of the stored first system information are invalid, as described at 506 in FIG. 5. In some cases, at 806 in FIG. 8, the UE determines that one or more blocks of the stored first system information are invalid due to the expiration of a validity duration timer and/or if the interval from when the system information was stored and/or most-recently validated otherwise exceeds a maximum time, as described at 506 in FIG. 5. In some cases, at 806 in FIG. 8, the UE determines that one or more blocks of the stored system information are invalid by checking for different information elements, as described at 506 in FIG. 5. In some cases, at 806 in FIG. 8, the UE determines that one or more blocks of the stored system information are invalid due to receipt of a paging message from the network, as described at 506 in FIG. 5.

At 808, the UE performs a service requirement procedure to determine at least one service requirement of the UE relating to the invalid stored system information. At 808, the service requirements of the UE relate to whether the invalid system information is required system information for the UE, for example, required to operate within the currently camped/serving cell of the base station. System information is required when such system information includes the information related to the service the UE wants to utilize and/or has already requested from the base station using the wireless link. In some cases, the system information could be required for the UE when the base station indicates to the UE that such system information is required (e.g., MIB and SIB1 may be required system information). In some cases, the system information could be required for the UE when the UE's capabilities support the system information (e.g., if a UE supports IoT capability, then the system information related to IoT is required system information for the UE). An example of the UE determining that the invalid system information is required system information for the UE at 808 is if the UE is an IoT device and the system information contains essential information for the functioning of the IoT device.

At 810, the UE determines that the invalid system information is not required for the UE and the UE maintains (e.g., keeps) or releases (e.g., discards) the existing stored system information and does not reacquire such system information even though the stored system information is invalid.

At 812, the UE determines that the invalid system information is required for the UE and acquires new system information from the base station, as described at 510 in FIG. 5. In some cases, at 812 in FIG. 8, the needed system information is not broadcast in the cell of the base station, and the UE acquires the new system information from the base station, as described at 510 in FIG. 5. In some cases, at 812 in FIG. 8, the needed system information is broadcast in the cell of the base station, and the UE acquires the new system information from the broadcast system information, as described at 510 in FIG. 5. The UE may overwrite the invalid system information with one or more blocks of the new (valid) system information. In some cases, at 812 in FIG. 8, the needed system information is sent by the base station to the UE through a dedicated message, as described at 510 in FIG. 5.

In method 900, the UE is in communication with a base station. At 902, the UE acquires first system information from the base station, as described at 502 in FIG. 5. At 904, the UE stores the first system information (e.g., as device data 314 at CRM 312 of FIG. 1, on the storage media 318 on CRM 312 of FIG. 1).

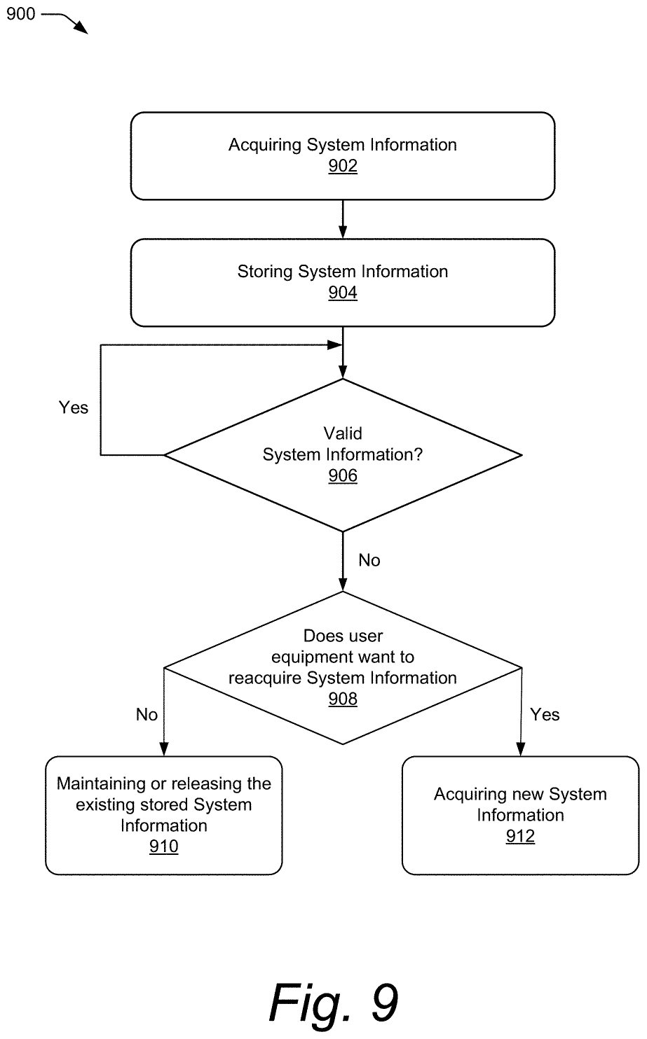

At 906, after a period of time, the UE determines that one or more blocks of the stored first system information are invalid, as described at 506 in FIG. 5. In some cases, at 906 in FIG. 9, the UE determines that one or more blocks of the stored system information are invalid due to the expiration of a validity duration timer and/or if the interval from when the system information was stored and/or most-recently validated otherwise exceeds a maximum time, as described at 506 in FIG. 5. In some cases, at 906 in FIG. 9, the UE determines that one or more blocks of the stored system information are invalid by checking for different information elements, as described at 506 in FIG. 5. In some cases, at 906 in FIG. 9, the UE determines that one or more blocks of the stored system information are invalid due to receipt of a paging message from the network, as described at 506 in FIG. 5.

At 908, the UE performs a service requirement procedure to determine at least one service requirement of the UE relating to the invalid stored system information. At 908, the service requirements of the UE relate to whether the UE wants to acquire and/or receive such invalid system information.

At 910, in response to the UE determining that the UE does not want to acquire and/or receive such invalid system information, the UE maintains (e.g., keeps) or releases (e.g., discards) the existing stored system information and does not reacquire such system information even though one or more blocks of the stored system information is invalid.

At 912, in response to the UE determining that it wants to acquire and/or receive such invalid system information, the UE acquires new system information from the base station, as described at 510 in FIG. 5. In some cases, at 912 in FIG. 9, the needed system information is not broadcast in the cell of the base station, and the UE acquires the new system information from the base station, as described at 510 in FIG. 5. In some cases, at 912 in FIG. 9, the needed system information is broadcast in the cell of the base station, and the UE acquires the new system information from the broadcast system information, as described at 510 in FIG. 5. The UE may overwrite the invalid system information with one or more blocks of the new (valid) system information. In some cases, at 912 in FIG. 9, the needed system information is sent by the base station to the UE through a dedicated message, as described at 510 in FIG. 5.

### EXAMPLES

In the following paragraphs, some examples are described:

### Example 1

An apparatus comprising: at least one antenna; a wireless transceiver configured to process a first system information message received via the at least one antenna from a base station; a system information control module configured to perform a system information acquisition procedure to acquire system information from the first system information message processed by the wireless transceiver, the system information comprising one or more blocks of system information; and a storage media configured to store the system information, wherein the system information control module is further configured to determine if one or more blocks of the stored system information are invalid, wherein in response to determining that one or more blocks of the stored system information are invalid, the system information control module determines at least one service requirement of the apparatus, and wherein the system information control module manages the system information based on the at least one service requirement of the apparatus.

### Example 2

The apparatus of example 1, wherein the at least one service requirement of the apparatus relates to whether the apparatus is capable of handling the system information determined to be invalid.

### Example 3

The apparatus of example 1, wherein the system information comprises one or more blocks of system information, wherein one or more of the one or more blocks of system information contains information regarding at least one service, and wherein the at least one service requirement of the apparatus relates to whether the apparatus is interested to receive the services which the invalid system information contains information regarding.

### Example 4

The apparatus of example 1, wherein the at least one service requirement of the apparatus relates to whether the invalid system information is required system information for the apparatus.

### Example 5

The apparatus of example 1, wherein the at least one service requirement of the apparatus relates to whether the apparatus wants to acquire such invalid system information.

### Example 6

The apparatus of example 1, wherein: the wireless transceiver is configured to process a second system information message received via the at least one antenna, the second system information message comprising second system information; and the storage media configured to overwrite the stored system information with the second system information responsive to the system information control module determining the at least one service requirement of the apparatus.

### Example 7

The apparatus of example 1, further comprising user equipment including the antenna, at least one processor, the wireless transceiver, the system information control module, and the storage media.

### Example 8

The apparatus of example 1, wherein the system information control module manages the system information based on the at least one service requirement of the apparatus by keeping the stored system information.

### Example 9

The apparatus of example 1, wherein the system information control module manages the system information based on the at least one service requirement of the apparatus by releasing the stored system information.

### Example 10

A method comprising: receiving a first system information message sent by a base station; applying a system information acquisition procedure to acquire first system information from the first system information message; storing the first system information; determining if one or more blocks of the stored first system information are invalid; performing a service requirement procedure to determine at least one service requirement of a user equipment relating to the one or more blocks of invalid first system information; wherein in response to performing the service requirement procedure: acquiring a second system information message from the base station, the second system information message including second system information; and overwriting one or more blocks of the invalid first system information with the second system information.

### Example 11

The method of example 10, further comprising keeping the stored system information.

### Example 12

The method of example 10 or example 11, further comprising releasing the stored system information.

### Example 13

The method of any of preceding examples 10-12, wherein the second system information message is received by the user equipment from a periodic transmission broadcast by the base station.

### Example 14

The method of any of preceding examples 10-13, wherein the second system information message is acquired via a dedicated message from the base station.

### Example 15

The method of any of preceding examples 10-14, wherein determining if one or more blocks of the stored first system information are invalid is performed by determining if a validity duration timer has expired.

### Example 16

The method of any of preceding examples 10-15, wherein determining if one or more blocks of the stored first system information are invalid is performed by checking if one or more information elements in the stored first system information are different from same information element(s) in a SystemInformationBlockType1 (SIB1) message received from the base station.

### Example 17

The method of any of preceding examples 10-16, wherein determining if one or more blocks of the stored first system information are invalid is triggered by receipt of a paging message from base station.

### Example 18

The method of any of preceding examples 10-17, wherein performing a service requirement procedure comprises determining whether a user equipment is capable of handling the one or more blocks of invalid first system information.

### Example 19

The method of any of preceding examples 10-18, wherein performing a service requirement procedure comprises determining whether a user equipment is interested to receive services which the invalid system information contains information regarding.

### Example 20

The method of any of preceding examples 10-19, wherein the first system information comprises one or more blocks of first system information, wherein one or more of the one or more blocks of first system information contains information regarding at least one service, and wherein performing a service requirement procedure comprises determining whether the invalid first system information is required system information for a user equipment.

### Example 21

The method of any of preceding examples 10-20, wherein the first system information comprises one or more blocks of first system information, wherein one or more of the one or more blocks of first system information contains information regarding at least one service, and wherein performing a service requirement procedure comprises determining whether a user equipment wants to acquire such invalid first system information.

### Example 22

The method of any of preceding examples 10-22, wherein performing a service requirement procedure comprises determining whether a user equipment is capable of handling the one or more blocks of invalid first system information or determining whether a user equipment is interested to receive services which the invalid system information contains information regarding.

### Example 23

The method of any of preceding examples 10-22, wherein the first system information comprises one or more blocks of first system information, wherein one or more of the one or more blocks of first system information contains information regarding at least one service, and wherein performing a service requirement procedure comprises determining whether the invalid first system information is required system information for a user equipment or determining whether a user equipment wants to acquire such invalid first system information.

### Example 24

A method comprising: receiving a first system information message sent by a base station; applying a system information acquisition procedure to acquire first system information from the first system information message; storing the first system information; determining if one or more blocks of the stored first system information are invalid, wherein determining if one or more blocks of the stored first system information are invalid is determined by at least one of: an expiration of a validity duration timer, determining that one or more information elements in the stored first system information are different from same information element(s) in a SystemInformationBlockType1 (SIB1) message received from the base station, or receipt of a paging message from base station; performing a service requirement procedure to determine at least one service requirement of a user equipment relating to the one or more blocks of invalid first system information; wherein in response to performing the service requirement procedure: acquiring a second system information message from the base station, the second system information message including second system information; and overwriting one or more blocks of the invalid first system information with the second system information.

### Example 25

A method performed by a user equipment in communication with a base station, the method comprising: receiving a first system information message including system information from the base station; storing the system information; determining that one or more blocks of the stored system information are invalid system information; responsive to determining that one or more blocks of the stored system information are invalid system information, determining at least one service requirement of the user equipment; and managing the stored system information based on the at least one service requirement of the user equipment.

### Example 26

The method of example 25, wherein the managing the stored system information based on the at least one service requirement of the user equipment comprises maintaining the stored system information.

### Example 27

The method of example 25, wherein the managing the stored system information based on the at least one service requirement of the user equipment comprises: acquiring a second system information message including the system information from the base station; and overwriting the invalid first system information with one or more blocks of the system information contained in the second system information message.

### Example 28

The method of example 25, further comprising: determining a user equipment service related to the stored system information, wherein determining the at least one service requirement of the user equipment comprises determining if the user equipment is capable of handling the determined user equipment service, wherein if the user equipment is capable of handling the determined user equipment service, then managing the stored system information based on the at least one service requirement of the user equipment comprises: acquiring a second system information message from the base station, the second system information message including second system information from the base station; and overwriting the invalid system information with one or more blocks of the system information contained in the second system information message, and wherein if the user equipment is not capable of handling the determined user equipment service, then managing the stored system information based on the at least one service requirement of the user equipment comprises maintaining the stored system information.

### Example 29

The method of example 25, further comprising: determining a user equipment service related to the stored system information, wherein the determining at least one service requirement of the user equipment comprises determining if a capability of the user equipment supports the determined user equipment service, wherein if the capability of the user equipment supports the determined user equipment service, then managing the stored system information based on the at least one service requirement of the user equipment comprises: acquiring a second system information message including the system information from the base station; and overwriting the invalid system information with one or more blocks of the system information contained in the second system information message, and wherein if the capability of the user equipment does not support the determined user equipment service, then managing the stored system information based on the at least one service requirement of the user equipment comprises maintaining the stored system information.

### Example 30

The method of example 28 or example 29, wherein the determined user equipment service related to the stored system information comprises at least one of: Minimization of Drive Test; or Multimedia Broadcast Multicast Service.

### Example 31

The method of example 25, wherein the determining the at least one service requirement of the user equipment comprises: determining if valid stored system information is required for the user equipment to operate within the cell, wherein if valid stored system information is required for the user equipment to operate within the cell, then managing the stored system information based on the at least one service requirement of the user equipment comprises: acquiring a second system information message including the system information from the base station; and overwriting the invalid system information with one or more blocks of the system information contained in the second system information message, and wherein if valid stored system information is not required for the user equipment to operate within the cell, then managing the stored system information based on the at least one service requirement of the user equipment comprises maintaining the stored system information.

### Example 32

The method of example 25, wherein the determining the at least one service requirement of the user equipment comprises: determining if the user equipment requires the invalid system information to operate within the cell, wherein if the user equipment requires the invalid system information to operate within the cell, then managing the stored system information based on the at least one service requirement of the user equipment comprises: acquiring a second system information message including the system information from the base station; and overwriting the invalid system information with one or more blocks of the system information contained in the second system information message, and wherein if the user equipment does not require the invalid system information to operate within the cell, then managing the stored system information based on the at least one service requirement of the user equipment comprises maintaining the stored system information.

### Example 33

The method of any of examples 27-32, wherein the acquiring the second system information message including the system information from the base station comprises: determining if the base station is broadcasting the second system information message including the system information; wherein if the base station is broadcasting the second system information message including the system information, then acquiring a second system information message including the system information from the base station further comprises: receiving the broadcast second system information message including the system information from the base station; and wherein if the base station is not broadcasting the second system information message including the system information, then acquiring a second system information message including the system information from the base station further comprises: sending a system information request to the base station; and receiving the second system information message including the system information from the base station.

### Example 34

The method of example 27 or example 33, wherein the acquiring the second system information message including the system information from the base station further comprises at least one of: receiving a periodic transmission broadcast of the base station; receiving a dedicated message from the base station; or sending a system information request to the base station.

### Example 35

The method of any of examples 27-34, wherein the determining that one or more blocks of the stored first system information are invalid comprises: checking if one or more information elements in the stored first system information are different from same information element(s) in the second system information received from the base station in the second system information message.

### Example 36

The method of any one of examples 27-34, wherein the determining that one or more blocks of the stored system information are invalid system information comprises: checking if one or more information elements in the stored system information are different from same information element(s) in the system information received from the base station in the second system information message.

### Example 37

The method of example 25 or example 26, further comprising: determining that valid stored system information is required for the user equipment to operate within the cell, and wherein managing the stored system information based on the at least one service requirement of the user equipment comprises acquiring a second system information message including the system information from the base station.

### Example 38

The method of any examples 25-37, wherein determining that one or more blocks of the stored system information are invalid system information comprises at least one of: determining if a validity duration timer has expired; determining if an interval from when the stored system information was stored exceeds a maximum time; or determining if an interval from when the stored system information was most-recently validated exceeds a maximum time.

### Example 39

The method of example 38, further comprising: starting a timer after storing the stored system information.

### Example 40

The method of any of examples 25-39, further comprising: receiving a paging message from the base station informing the user equipment about a system information change; and responsive to receiving the paging message, performing the determining that one or more blocks of the stored system information are invalid system information.

### Example 41

A user device comprising: a processor; and a computer-readable storage media having stored thereon instructions that, responsive to execution by the processor, cause the processor to execute the method of any of examples 25-40.

### CONCLUSION

Although techniques and device for the handling of invalid system information in UE have been described in language specific to features and/or methods, it is to be understood that the subject of the appended claims is not necessarily limited to the specific features or methods described. Rather, the specific features and methods are disclosed as example implementations of the handling of invalid system information in UE.

What is claimed is:

1. A method performed by a user equipment in communication with a base station, the method comprising:
receiving a first system information message including first system information from the base station;
storing the first system information;
determining that one or more blocks of the stored first system information are invalid system information;
responsive to determining that one or more blocks of the stored first system information are invalid system information, determining at least one service requirement of the user equipment; and
managing the stored first system information based on the at least one service requirement of the user equipment.

2. The method of claim 1, wherein the managing the stored first system information based on the at least one service requirement of the user equipment comprises:
determining if the base station is broadcasting a second system information message including second system information;
wherein if the base station is broadcasting the second system information message including the second system information, then
receiving the broadcasted second system information message including the second system information from the base station; and
wherein if the base station is not broadcasting the second system information message including the second system information, then:
sending a system information request to the base station; and
receiving the second system information message including the second system information from the base station; and
overwriting the invalid system information with one or more blocks of the second system information contained in the second system information message.

3. The method of claim 1, further comprising:
determining a user equipment service related to the stored first system information;
determining if the user equipment is capable of handling the determined user equipment service;
wherein if the user equipment is capable of handling the determined user equipment service, then managing the stored first system information based on the at least one service requirement of the user equipment comprises:
acquiring a second system information message including second system information from the base station; and
overwriting the invalid system information with one or more blocks of the second system information contained in the second system information message; and
wherein if the user equipment is not capable of handling the determined user equipment service, then managing the stored first system information based on the at least one service requirement of the user equipment comprises maintaining the stored first system information.

4. The method of claim 3, wherein the acquiring the second system information message including the second system information from the base station comprises:
determining if the base station is broadcasting the second system information message including the second system information;
wherein if the base station is broadcasting the second system information message including the second system information, then
receiving the broadcasted second system information message including the second system information from the base station; and
wherein if the base station is not broadcasting the second system information message including the second system information, then:
sending a system information request to the base station; and
receiving the second system information message including the second system information from the base station.

5. The method of claim 1, further comprising:
determining a user equipment service related to the stored first system information;
determining if a capability of the user equipment supports the determined user equipment service;
wherein if the capability of the user equipment supports the determined user equipment service, then managing the stored first system information based on the at least one service requirement of the user equipment comprises:
acquiring a second system information message including second system information from the base station; and
overwriting the invalid system information with one or more blocks of the second system information contained in the second system information message; and
wherein if the capability of the user equipment does not support the determined user equipment service, then managing the stored first system information based on the at least one service requirement of the user equipment comprises maintaining the stored first system information.

6. The method of claim 5, wherein the acquiring the second system information message including the second system information from the base station comprises:
determining if the base station is broadcasting the second system information message including the second system information;
wherein if the base station is broadcasting the second system information message including the second system information, then:
receiving the broadcasted second system information message including the second system information from the base station; and
wherein if the base station is not broadcasting the second system information message including the second system information, then:
sending a system information request to the base station; and
receiving the second system information message including the second system information from the base station.

7. The method of claim 1, wherein the determining the at least one service requirement of the user equipment comprises:
determining if valid stored first system information is required for the user equipment to operate within a cell of the base station;
wherein if valid stored first system information is required for the user equipment to operate within the cell of the base station, then managing the stored first system information based on the at least one service requirement of the user equipment comprises:
acquiring a second system information message including second system information from the base station; and
overwriting the invalid system information with one or more blocks of the second system information contained in the second system information message; and
wherein if valid stored first system information is not required for the user equipment to operate within the cell of the base station, then managing the stored first system information based on the at least one service requirement of the user equipment comprises maintaining the stored first system information.

8. The method of claim 7, wherein the acquiring the second system information message including the second system information from the base station comprises:
determining if the base station is broadcasting the second system information message including the second system information;
wherein if the base station is broadcasting the second system information message including the second system information, then:
receiving the broadcasted second system information message including the second system information from the base station; and
wherein if the base station is not broadcasting the second system information message including the second system information, then:
sending a system information request to the base station; and
receiving the second system information message including the second system information from the base station.

9. The method of claim 1, wherein the determining the at least one service requirement of the user equipment comprises:
determining if the user equipment requires the invalid system information to operate within a cell of the base station;
wherein if the user equipment requires the invalid system information to operate within the cell of the base station, then managing the stored first system information based on the at least one service requirement of the user equipment comprises:
acquiring a second system information message including second system information from the base station; and
overwriting the invalid system information with one or more blocks of the second system information contained in the second system information message; and
wherein if the user equipment does not require the invalid system information to operate within the cell of the base station, then managing the stored first system information based on the at least one service requirement of the user equipment comprises maintaining the stored first system information.

10. The method of claim 9, wherein the acquiring the second system information message including the second system information from the base station comprises:
determining if the base station is broadcasting the second system information message including the second system information;
wherein if the base station is broadcasting the second system information message including the second system information, then:
receiving the broadcasted second system information message including the second system information from the base station; and
wherein if the base station is not broadcasting the second system information message including the second system information, then:
sending a system information request to the base station; and
receiving the second system information message including the second system information from the base station.

11. The method of claim 1, wherein the determining that one or more blocks of the stored first system information are invalid system information comprises at least one of:
determining if a validity duration timer has expired;
determining if an interval from when the stored first system information was stored exceeds a maximum time; or
determining if an interval from when the stored first system information was most-recently validated exceeds a maximum time.

12. The method of claim 1, further comprising:
receiving a paging message from the base station informing the user equipment about a system information change; and
responsive to receiving the paging message, performing the determining that one or more blocks of the stored first system information are invalid system information.

13. The method of claim 1, wherein the managing the stored first system information based on the at least one service requirement of the user equipment comprises:
maintaining the stored first system information; or
acquiring a second system information message including second system information from the base station and overwriting the invalid system information with one or more blocks of the second system information.

14. A user equipment (UE) apparatus comprising:
a processor;
one or more transceivers; and
a computer-readable storage media (CRM) having stored thereon instructions that, responsive to execution by the processor, cause the processor to perform operations comprising:
receive, using the one or more transceivers, a first system information message including first system information from a base station;
store the first system information on the CRM;
determine that one or more blocks of the stored first system information are invalid system information;
responsive to determining that one or more blocks of the stored first system information are invalid system information, determine at least one service requirement of the UE apparatus; and
manage the stored first system information based on the at least one service requirement of the UE apparatus.

15. The UE apparatus of claim 14, wherein the operation to manage the stored first system information based on the at least one service requirement of the UE apparatus further comprises the CRM having stored instructions that, responsive to execution by the processor, cause the processor to perform further operations comprising:
determine if the base station is broadcasting a second system information message including second system information,
wherein if the base station is broadcasting the second system information message including the second system information, then:
acquire, using the one or more transceivers, the broadcasted second system information message including the second system information from the base station, and
wherein if the base station is not broadcasting the second system information message including the second system information, then:
send, using the one or more transceivers, a system information request to the base station, and
receive, using the one or more transceivers, the second system information message including the second system information from the base station.

16. The UE apparatus of claim 14, wherein the CRM has stored instructions that, responsive to execution by the processor, cause the processor to further perform operations comprising:
determine a user equipment service related to the stored first system information; and
determine if the UE apparatus is capable of handling the determined user equipment service,
wherein if the UE apparatus is capable of handling the determined user equipment service, then the operation to manage the stored first system information based on the at least one service requirement of the UE apparatus further comprises the CRM having stored instructions that, responsive to execution by the processor, cause the processor to perform further operations comprising:
acquire, using the one or more transceivers, the second system information message including the second system information from the base station, and
overwrite the invalid system information stored on the CRM with one or more blocks of the second system information contained in the second system information message, and
wherein if the UE apparatus is not capable of handling the determined user equipment service, then the operation to manage the stored first system information based on the at least one service requirement of the UE apparatus comprises the processor maintaining the stored first system information.

17. The UE apparatus of claim 14, wherein the processor further performs operations comprising:
determine a user equipment service related to the stored first system information; and
determine if a capability of the UE apparatus supports the determined user equipment service,
wherein if the capability of the UE apparatus supports the determined user equipment service, then the operation to manage the stored first system information based on the at least one service requirement of the UE apparatus includes the processor performing operations comprising:
acquire, using the one or more transceivers, a second system information message including second system information from the base station, and
overwrite the invalid system information stored on the CRM with one or more blocks of the second system information contained in the second system information message, and
wherein if the capability of the UE apparatus does not support the determined user equipment service, then the operation to manage the stored first system information based on the at least one service requirement of the UE apparatus comprises the processor maintaining the stored first system information.

18. The UE apparatus of claim 14, wherein the processor further performs operations comprising:
determine if valid stored first system information is required for the UE apparatus to operate within a cell of the base station;
wherein if valid stored first system information is required for the UE apparatus to operate within the cell of the base station, then the operation to manage the stored first system information based on the at least one service requirement of the UE apparatus comprises the processor performing operations comprising:
acquire a second system information message including second system information from the base station, and
overwrite the invalid system information stored on the CRM with one or more blocks of the second system information contained in the second system information message; and
wherein if valid stored first system information is not required for the UE apparatus to operate within the cell of the base station, then the operation of manage the stored first system information based on the at least one service requirement of the UE apparatus comprises the processor performing operations comprising maintain the stored first system information.

19. The UE apparatus of claim 14, wherein the operation to determine one or more blocks of the stored first system information are invalid system information comprises the processor performing operations to:
determine if a validity duration timer has expired;
determine if an interval from when the stored first system information was stored exceeds a maximum time; or
determine if an interval from when the stored first system information was most-recently validated exceeds a maximum time

20. The UE apparatus of claim 14, wherein the processor performs further operations comprising:
receive, using the one or more transceivers, a paging message from the base station informing the UE apparatus about a system information change; and
responsive to receiving the paging message, perform the operation to determine that one or more blocks of the stored first system information are invalid system information.
